(19) United States
(12) Patent Application Publication
(10) Pub. No.: US 2026/0196659 A1
(43) Pub. Date: Jul. 9, 2026

(54) TRACTION BATTERY PACK WITH PLATE ASSEMBLY HAVING A MELTABLE BARRIER

(71) Applicant: Ford Global Technologies, LLC, Dearborn, MI (US)

(72) Inventors: Di Zhu, Novi, MI (US); Mariel Pettinaro, Dearborn, MI (US); Liwen Zhang, Novi, MI (US); Shuya Shark Yamada, Novi, MI (US)

(21) Appl. No.: 19/010,918

(22) Filed: Jan. 6, 2025

(51) Int. Cl. H01M 50/375; H01M 10/658; H01M 50/211; B60L 50/64

(52) U.S. Cl. CPC H01M 50/375; H01M 10/658; H01M 50/211; B60L 50/64; H01M 2220/20

(57) ABSTRACT

A battery pack assembly includes a cell stack having battery cells disposed along a cell stack axis and a plate assembly alongside the cell stack. The plate assembly includes a frame that establishes a plurality of vent openings. The plate assembly further includes one or more meltable barriers that melt to permit a flow of vent byproducts through one or more of the vent openings.

### TECHNICAL FIELD

This disclosure relates generally to barriers within a battery pack and, more particularly, to a plate assembly having barriers that can melt to provide paths for vent byproducts to move through the plate assembly.

### BACKGROUND

Electrified vehicles differ from conventional motor vehicles because electrified vehicles include a drivetrain having one or more electric machines. The electric machines can drive the electrified vehicle instead of, or in addition to, an internal combustion engine. A traction battery pack assembly can power the electric machines.

### SUMMARY

In some aspects, the techniques described herein relate to a battery pack assembly, including: a cell stack having a plurality of battery cells disposed along a cell stack axis; and a plate assembly alongside the cell stack, the plate assembly including a frame that establishes a plurality of vent openings, the plate assembly further including one or more meltable barriers that melt to permit a flow of vent byproducts through one or more of the vent openings.

In some aspects, the techniques described herein relate to a battery pack assembly, wherein the frame has a frame melt temperature and the one or more meltable barriers each have a meltable barrier melt temperature that is lower than the frame melt temperature.

In some aspects, the techniques described herein relate to a battery pack assembly, wherein the one or more meltable barriers each held within at least one of the vent openings.

In some aspects, the techniques described herein relate to a battery pack assembly, wherein some of the vent openings are plugged by the one or more meltable barriers and others of the vent openings are covered by a flap of material without being plugged by the one or more meltable barriers.

In some aspects, the techniques described herein relate to a battery pack assembly, wherein the flap of material is a mica flap.

In some aspects, the techniques described herein relate to a battery pack assembly, wherein the frame is a silicate-based material.

In some aspects, the techniques described herein relate to a battery pack assembly, wherein the silicate-based material is mica.

In some aspects, the techniques described herein relate to a battery pack assembly, wherein the one or more meltable barriers are a polymer-based material.

In some aspects, the techniques described herein relate to a battery pack assembly. wherein the one or more meltable barriers are polypropylene.

In some aspects, the techniques described herein relate to a battery pack assembly, wherein the frame is a polymer-based material and the one or more meltable barriers are a silicate-based material.

In some aspects, the techniques described herein relate to a battery pack assembly, wherein the one or more meltable barriers are one or more molded meltable barriers.

In some aspects, the techniques described herein relate to a battery pack assembly, wherein the one or more meltable barriers are at least partially adhesively secured to the frame.

In some aspects, the techniques described herein relate to a battery pack assembly, wherein the plurality of battery cells are a plurality of pouch cells.

In some aspects, the techniques described herein relate to a battery pack assembly, further including at least one thermal barrier disposed axially between battery cells within the plurality of battery cells.

In some aspects, the techniques described herein relate to a battery pack assembly, wherein the one or more meltable barriers are one or more thermal barrier holders that secure the at least one thermal barrier relative to the frame.

In some aspects, the techniques described herein relate to a battery pack assembly, wherein the vent byproducts are discharged from one or more of the battery cells.

In some aspects, the techniques described herein relate to a battery pack assembly, including: a cell stack having a plurality of battery cells disposed along a cell stack axis; and a frame holding at least one meltable barrier, the at least one meltable barrier having a melt temperature that is lower than a melt temperature of the frame.

In some aspects, the techniques described herein relate to a battery pack assembly, wherein the at least one meltable barrier melts to permit a flow of vent byproducts from the cell stack through the frame.

In some aspects, the techniques described herein relate to a battery pack assembly, further including a plurality of flaps, wherein the frame includes a plurality of vent openings each covered at least one of the flaps in the plurality of flaps.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates an expanded perspective view of the traction battery pack of FIG. 1.

FIG. 3 illustrates an expanded perspective view of a battery array from the traction battery pack of FIG. 2 showing a battery cell of the battery array venting.

FIG. 4 is a side view of the battery array of FIG. 3 prior to vent byproducts from one or more of the battery cells passing through vent openings in a side plate assembly of the battery array.

FIG. 5 is a side view of the battery array of FIG. 3 showing vent byproducts from one or more of the battery cells passing through vent openings in the side plate assembly.

FIG. 6 illustrates a top view of a portion of a battery array according to another exemplary aspect of the present disclosure.

FIG. 7 illustrates the top view of FIG. 6 when a battery cell of the battery array is venting.

### DETAILED DESCRIPTION

This disclosure details example traction battery pack assemblies having plate assemblies that include meltable barriers. During a venting event, the meltable barriers can melt to establish a vent opening within the plate assembly. Vent byproducts emitted from one or more battery cells can move through the vent opening from a first side of the plate assembly to an opposite, second side of the plate assembly. Moving the vent byproducts through the vent opening can keep the vent byproducts away from battery cells that are not venting.

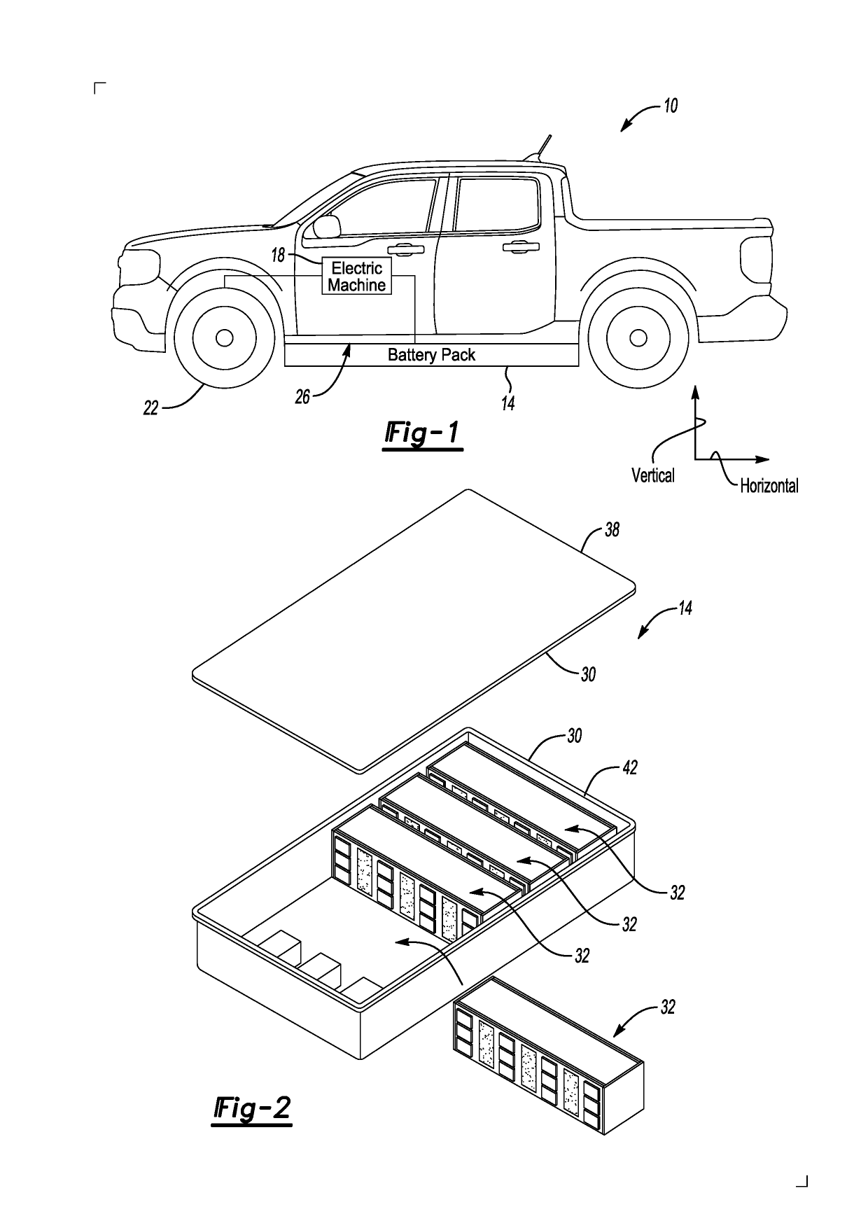

With reference to FIG. 1, an electrified vehicle 10 includes a traction battery pack assembly 14, an electric machine 18, and wheels 22. The traction battery pack assembly 14 powers the electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

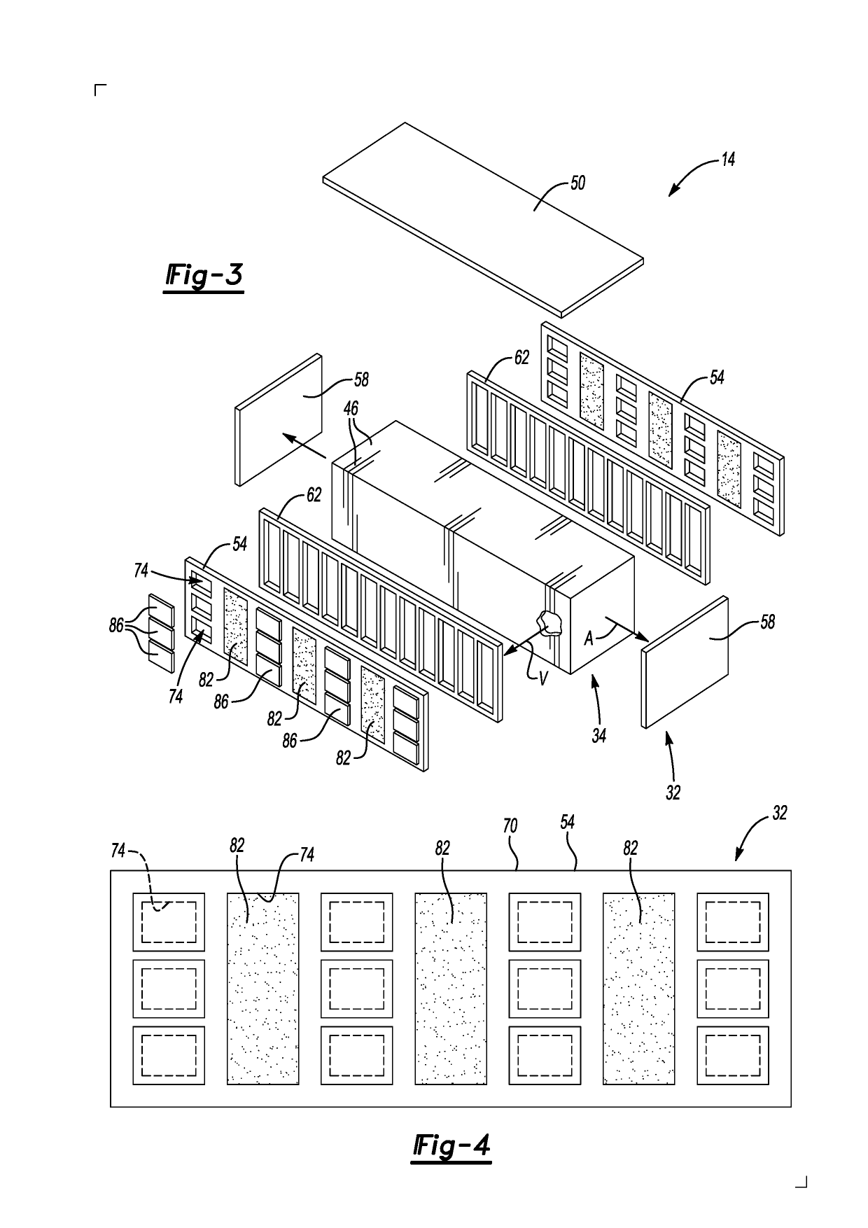

With reference now to FIGS. 2 to 5, the traction battery pack assembly 14 includes an enclosure assembly 30 that encloses, among other things, a plurality of battery arrays 32 each, in this example, having a cell stack 34.

In the exemplary embodiment, the enclosure assembly 30 includes an enclosure cover 38 and an enclosure tray 42. The enclosure cover 38 can be secured to the enclosure tray 42 via welds, mechanical fasteners, etc.

Each of the cell stacks 34 includes a plurality of individual battery cells 46 disposed along a cell stack axis A. The battery cells 46 are pouch-style battery cells in this example. The plurality of battery cells (or simply, “cells”) 46 can supplying electrical power to various components of the electrified vehicle 10. Groups of the cells 46 are stacked side-by-side relative to one another along the respective cell stack axis A to construct each of the cell stack 34.

In this example, the battery pack assembly 14 includes four battery arrays 32, and thus four cell stacks 34, housed within the interior of the enclosure assembly 30. The four cell stacks 34 are horizontally adjacent to each other. Horizontal and vertical, for purposes of this disclosure, are with reference to ground and a general orientation of the electrified vehicle 10 during operation.

Although a specific number of cells 46 and battery arrays 32 are illustrated in the various figures of this disclosure, the traction battery pack assembly 14 could include any number of cells 46 and battery arrays 32. In other words, this disclosure is not limited to the specific configuration of cells 46 and battery arrays 32 depicted and described herein.

In this embodiment, the cells 46 are lithium-ion pouch cells. In another example, the cell are prismatic cells. Battery cells having other geometries (cylindrical, jelly-roll, etc.) and/or chemistries (nickel-metal hydride, lead-acid, etc.) could alternatively be utilized within the scope of this disclosure.

The cell stacks 34 can be held within the enclosure assembly 30 by a plurality of plate assemblies. In this example, the plate assemblies for each of the cell stacks 34 includes: a top plate assembly 50, a pair of side plate assemblies 54, and a pair of end plate assemblies 58. The top plate assembly 50 covers the vertically upward facing sides of the cells 46. The side plate assemblies 54 are positioned alongside the opposing horizontally facing sides of the cells 46. The end plate assemblies 58 are disposed at opposing axial ends of the cell stacks 34. Opposing axial ends of the side plate assemblies 54 are secured directly to the end plates assemblies 58 in this example.

A busbar assembly 62 is sandwiched between each of the side plate assemblies 54 and the cells 46. Terminals of the cells 46 can be connected to busbars of the busbar assembly 62 to electrically connect the cells 46 to other cells 46 and other components of the battery pack assembly 14. The busbars are omitted from the figures for drawing clarity.

The side plate assemblies 54 each include, in this example, a frame 70 having a plurality of vent openings 74. At least some of the vent openings 74 are filled or plugged with one or more meltable barriers 82. At least some of the vent openings 74 are not filled or plugged with a meltable barrier but are instead covered by a flap 86.

From time to time, temperature and pressure within one or more of the cells 46 can increase and cause the cell 46 to rupture and discharge relatively high-temperature vent byproducts V from inside the cell 46. In this example, the vent byproducts V can move outward away from the respective cell stack axis A through openings in the busbar assembly 62. The vent byproducts V can then move through the vent openings 74 with the flap 86.

Providing pathways that permit the vent byproducts V to move outward away from the cell stack 34 can help to keep the vent byproducts V away from cells 46 that are not venting. Vent byproducts V moving adjacent to cells 46 that are not venting could, for example, raise a temperature of those cells 46 such that those cells 46 start venting and a thermal event cascades through the cells 46 of the battery pack assembly 14.

The vent openings 74 can be positioned and sized as desired. A number of the vent openings 74 filled with the meltable barrier 82 or covered by the flap 86 can be adjusted. In some examples, the vent openings 74 are elongated an oriented to align with an orientation of the cells 46.

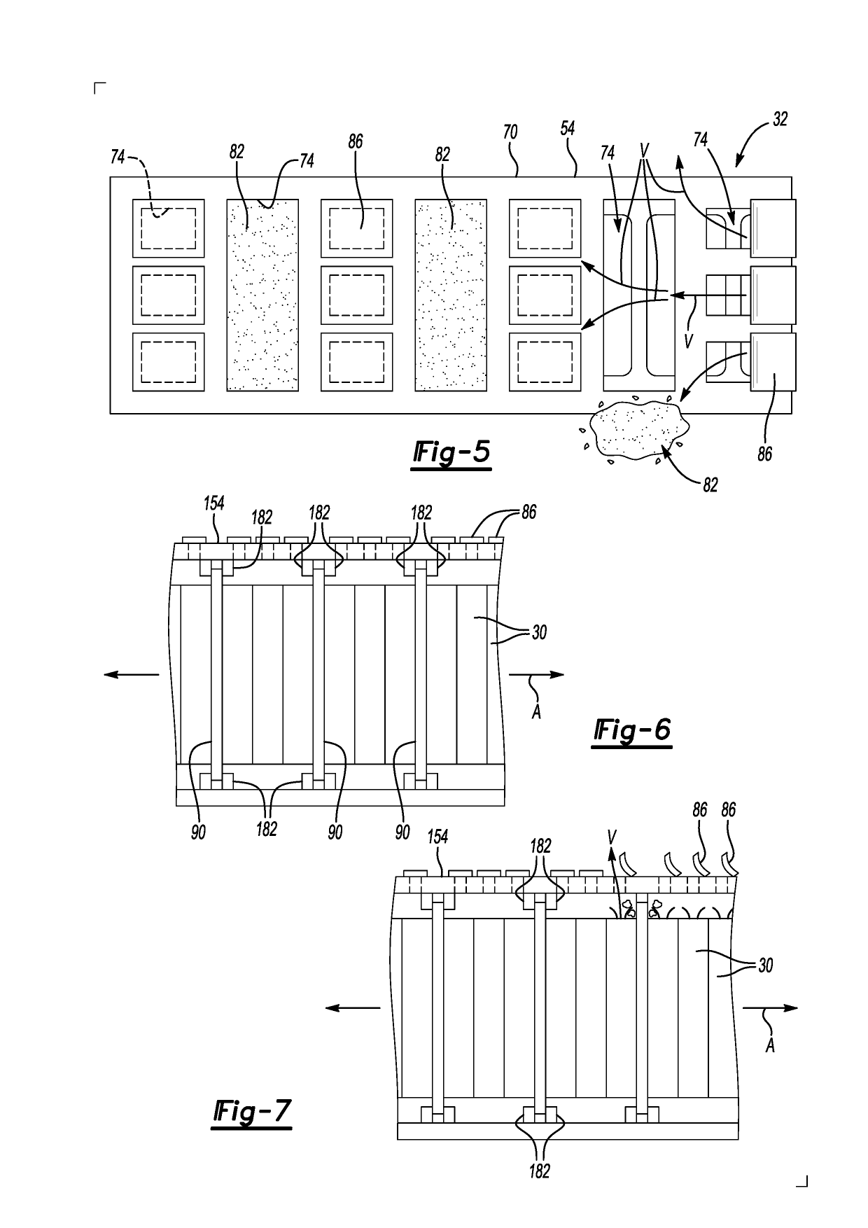

The meltable barriers 82 can melt to allow the vent byproducts V to pass through the vent openings 74 filled with one or more meltable barriers 82. Thermal energy from the vent byproducts V can cause the meltable barriers 82 to melt, which opens the vent openings 74 in the frame 70 as shown in FIG. 5.

In this example, the frame 70 has a frame melt temperature and the meltable barriers 82 have a meltable barrier melt temperature that is lower than the frame melt temperature. Thus, when thermal energy levels near an area of side plate assembly 54 increases, the meltable barrier 82 in that area will melt before the frame 70.

During manufacturing of the side plate assembly 54, the frame 70 can be overmolded around the meltable barriers 82 to hold the meltable barriers 82 with the frame 70. A person having skill in this art would be able to structurally distinguish an overmolded component from one that is not overmolded. Specifying that a component is overmolded is thus a structural distinction. In other examples, the meltable barriers 82 could be molded separately from the frame 70 and then adhesively secured within the respective vent opening 74 of the frame 70 to fill that vent opening 74.

Areas where the meltable barriers 82 transition to the frame 70 can be thinned relative to surrounding areas. Thinning these areas can facilitate removing the meltable barrier 82 from within the vent opening 74 when the meltable barrier 82 is melting due to thermal energy from vent byproducts V.

In an example, the frame 70 can be a silicate-based material, and the meltable barriers 82 can be a polymer-based material. In a more specific example, the frame 70 can be mica and the meltable barriers 82 can be polypropylene or polyethylene.

Incorporating the meltable barriers 82 within at least some of the vent openings 74 can strengthen the side plate assembly 54 when compared to a design that does not close some of the vent openings 74 with one or more meltable barriers 82. That is, side plate assembly 54 with at least some of the vent openings 74 filled with one or more of the meltable barriers 82 can be stronger than a side plate assembly having the same vent openings, but without any of the vent openings filled with meltable barriers.

In this example, not all the vent openings 74 are filled with one or more meltable barriers 82. At least some of the vent openings 74 are covered by the flap 86. The flap 86 can be a mica flap that is, for example, 0.5 millimeters thick. The flap 86 can be adhesively secured to a surface of the frame 70 opposite the cell stack 34. The vent byproducts V from one or more of the cells 46 can press move the flap 86 so that vent byproducts V can move through the respective vent opening 74 away from the cell stack 34 as shown in FIG. 5.

In some examples, the flaps 86 can be more securely fastened to the frame 70 in some areas, say along one of the sides. This can encourage the flaps 86 to open in a desired direction during a venting event so that the vent byproducts V are directed in a desired direction. In some examples, the flaps 86 can include creases to encourage folding of the flaps 86 during a venting event.

The meltable barriers 82 and the flaps 86 are described in connection with the side plate assemblies 54 but could instead or additionally be used with the top plate assembly 50, the end plate assemblies 58, or both.

With reference to FIGS. 6, another example side plate assembly 154 includes meltable barriers 182 that are used as holders to hold thermal barriers 90. During a thermal event, vent byproducts V can introduce thermal energy to at least some of the meltable barriers 182 to melt those thermal barriers 90 as shown in FIG. 7. The vent byproducts V can then flow past the area formerly occupied by the meltable barrier 182. Busbars and a busbar frame are not shown in FIGS. 6 and 7 for clarity.

Features of the disclosed examples can include a frame assembly that includes a meltable barrier. During ordinary operation when no battery cells are venting, the meltable barrier can help to strengthen the frame assembly. When battery cells are venting, the meltable barrier can melt to provide open areas within the frame through which the vent byproducts can move away from the battery cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cell stack having a plurality of battery cells disposed along a cell stack axis; and
a plate assembly alongside the cell stack, the plate assembly including a frame that establishes a plurality of vent openings, the plate assembly further including one or more meltable barriers that melt to permit a flow of vent byproducts through one or more of the vent openings.

2. The battery pack assembly of claim 1, wherein the frame has a frame melt temperature and the one or more meltable barriers each have a meltable barrier melt temperature that is lower than the frame melt temperature.

3. The battery pack assembly of claim 1, wherein the one or more meltable barriers each held within at least one of the vent openings.

4. The battery pack assembly of claim 1, wherein some of the vent openings are plugged by the one or more meltable barriers and others of the vent openings are covered by a flap of material without being plugged by the one or more meltable barriers.

5. The battery pack assembly of claim 4, wherein the flap of material is a mica flap.

6. The battery pack assembly of claim 1, wherein the frame is a silicate-based material.

7. The battery pack assembly of claim 6, wherein the silicate-based material is mica.

8. The battery pack assembly of claim 1, wherein the one or more meltable barriers are a polymer-based material.

9. The battery pack assembly of claim 8. wherein the one or more meltable barriers are polypropylene.

10. The battery pack assembly of claim 1, wherein the frame is a polymer-based material and the one or more meltable barriers are a silicate-based material.

11. The battery pack assembly of claim 1, wherein the one or more meltable barriers are one or more molded meltable barriers.

12. The battery pack assembly of claim 1, wherein the one or more meltable barriers are at least partially adhesively secured to the frame.

13. The battery pack assembly of claim 1, wherein the plurality of battery cells are a plurality of pouch cells.

14. The battery pack assembly of claim 1, further comprising at least one thermal barrier disposed axially between battery cells within the plurality of battery cells.

15. The battery pack assembly of claim 14, wherein the one or more meltable barriers are one or more thermal barrier holders that secure the at least one thermal barrier relative to the frame.

16. The battery pack assembly of claim 1, wherein the vent byproducts are discharged from one or more of the battery cells.

17. A battery pack assembly, comprising:
a cell stack having a plurality of battery cells disposed along a cell stack axis; and
a frame holding at least one meltable barrier, the at least one meltable barrier having a melt temperature that is lower than a melt temperature of the frame.

18. The battery pack assembly of claim 17, wherein the at least one meltable barrier melts to permit a flow of vent byproducts from the cell stack through the frame.

19. The battery pack assembly of claim 17, further comprising a plurality of flaps, wherein the frame includes a plurality of vent openings each covered at least one of the flaps in the plurality of flaps.
